(19) United States
(12) Patent Application Publication
(10) Pub. No.: US 2024/0237857 A1
(43) Pub. Date: Jul. 18, 2024

(54) FOOD MIXING MACHINE WITH ACCESSORY AND BOWL IDENTIFICATION AND ASSOCIATED CONTROL FUNCTIONS

(71) Applicant: ILLINOIS TOOL WORKS INC., Glenview, IL (US)

(72) Inventors: Lawrence S. LEUNG, Troy, OH (US); Thomas P. Jones, Wilmington, OH (US); Jesse W. GRUBER, Vandalia, OH (US)

(21) Appl. No.: 18/408,226

(22) Filed: Jan. 9, 2024

Related U.S. Application Data
(60) Provisional application No. 63/439,421, filed on Jan. 17, 2023.

(51) Int. Cl. A47J 43/07

(52) U.S. Cl. CPC A47J 43/0755; A47J 43/0727; A47J 2043/04472

(57) ABSTRACT

A food mixing machine includes a head extending over a bowl receiving location, the head including an output shaft driven in a planetary manner and configured to receive a mixing tool, and a sensor system configured for detecting (i) a bowl identifier of a radio frequency identification component carried by a bowl mounted at the bowl receiving location and (ii) a mixing tool identifier of a radio frequency identification component carried by a mixing tool connected to the output shaft. Control actions based upon the detected bowl identifier and the detected mixing tool identifier are then carried out.

### TECHNICAL FIELD

This application relates generally to commercial food mixing machines used to mix food products and, more specifically, to a food mixing machine that identifies mixing machine accessories and is configured for advanced control functionality based upon such identification.

### BACKGROUND

Typical food mixing machines incorporate an electric motor, a transmission system, a frame, a head extending over a bowl receiving location, and an output shaft driven in a planetary manner, where the output shaft is configured to releasably receive a variety of mixing tools (e.g., a dough hook, a flat beater or a wire whip connected to the output shaft). Food mixing machines, and the associated components such as bowls and mixing tools, come in a variety of sizes and configurations. It is not unusual for a commercial establishment to have different size mixing machines and associated tools.

A mixing machine capable of identifying an output shaft attached mixing tool is described in U.S. Pat. No. 11,039,715, with the machine configured to compare actual load conditions to a stored load profile associated with the identified mixing tool. This system is useful for avoiding, or alerting to, load out of bound conditions. However, improvements and enhancements in mixing machine operation are sought.

Accordingly, it would be desirable to provide a mixing machine capable of providing enhanced control functionality based upon identification of the attached mixing tool.

### SUMMARY

In one aspect, a food mixing machine includes a head extending over a bowl receiving location, the head including an output shaft driven in a planetary manner and configured to receive a mixing tool, and a sensor system positioned for detecting a bowl identifier of a radio frequency identification component carried by a bowl mounted at the bowl receiving location.

In implementations, the sensor system is configured for detecting a mixing tool identifier of a radio frequency identification component carried by a mixing tool connected to the output shaft.

In implementations, the sensor system includes at least one radio frequency identification reader connected with at least one radio frequency identification antenna.

In implementations, the at least one radio frequency identification antenna comprises a single radio frequency identification antenna positioned for detecting both the radio frequency identification component carried by the mixing tool and the radio frequency identification component carried by the bowl.

In implementations, the at least one radio frequency identification antenna comprises a first radio frequency identification antenna positioned for detecting the radio frequency identification component carried by the mixing tool, and a second radio frequency identification antenna positioned for detecting the radio frequency identification component carried by the bowl.

In implementations, a controller is associated with the sensor system, the controller configured to utilize both the detected mixing tool identifier and the detected bowl identifier as a basis for implementing a control function of the food mixing machine.

In implementations, the controller is configured to determine whether the detected mixing tool identifier and the detected bowl identifier indicate a specified condition and, if so, to generate an operator alert of the condition.

In implementations, the controller is configured to establish an operating bowl location based upon the detected mixing tool identifier and the detected bowl identifier so as to provide a suitable relative positioning of the mixing tool within the bowl for a mixing operation.

In implementations, the controller is configured to establish one or more of a mix speed, a mix direction, a mix time setting, a motor acceleration rate, a motor deceleration rate, an allowable temperature limit or an allowable current limit based upon at least one of a detected bowl identifier or a detected mixing tool identifier.

In implementations, the mixing machine includes a power take off hub on the head, wherein the sensor system is further configured for detecting a hub tool identifier of a processing tool attached to the power take off hub.

In implementations, a controller is associated with the sensor system, the controller configured to prevent operation of the mixing machine if both a hub tool identifier and a mixing tool identifier are detected.

In implementations, a controller is associated with the sensor system, the controller configured to: prevent operation of the mixing machine unless a bowl identifier is detected and verified as acceptable for the mixing machine; and/or prevent operation of the mixing machine unless a mixing tool identifier is detected and verified as acceptable for the mixing machine

In implementations, a scannable RFID component on the mixing machine for identifying the mixing machine.

In implementations, the sensor system includes at least one radio frequency identification reader/writer connected with at least one radio frequency identification antenna for writing operating data to the scannable RFID component of the mixing machine.

In another aspect, a food mixing machine includes a head extending over a bowl receiving location, the head including an output shaft driven in a planetary manner and configured to receive a mixing tool, and a sensor system configured for detecting (i) a bowl identifier of a radio frequency identification component carried by a bowl mounted at the bowl receiving location and (ii) a mixing tool identifier of a radio frequency identification component carried by a mixing tool connected to the output shaft. A controller is associated with the sensor system, the controller configured to implement a control function of the food mixing machine based upon at least both of the detected mixing tool identifier and the detected bowl identifier, wherein the control function is at least one of (i) display of an operator notification or (ii) establishment of an operating bowl location so as to provide a suitable relative positioning of the mixing tool within the bowl for a mixing operation.

In a further aspect, a food mixing machine includes a head extending over a bowl receiving location, the head including an output shaft driven in a planetary manner and configured to receive a mixing tool, and a first readable/writable radio frequency identification component on the mixing machine that stores both (i) a readable identifier of the mixing machine and (ii) readable data regarding historical mixing machine operation.

The details of one or more embodiments are set forth in the accompanying drawing and the description below. Other features, objects, and advantages will be apparent from the description and drawing, and from the claims.

### BRIEF DESCRIPTION OF THE DRAWINGS

FIG. 1 is a side elevation of an exemplary mixing machine;

FIG. 2 is a perspective view of the exemplary mixing machine;

FIG. 3 is partial cross-section of the mixing machine;

FIGS. 4 and 5 show an exemplary antenna position on the mixer head;

FIG. 6 shows an exemplary antenna position on the mixer column;

FIG. 7 shows a mixing tool with an identifier located on a side of the tool mount; and

FIG. 8 shows a mixing tool with an identifier located in a recess of the end face of the tool mount.

### DETAILED DESCRIPTION

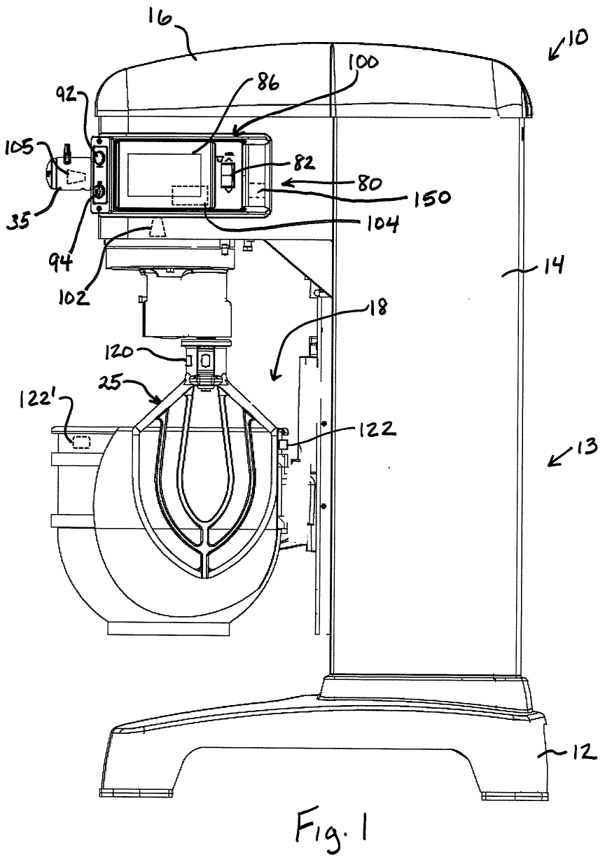

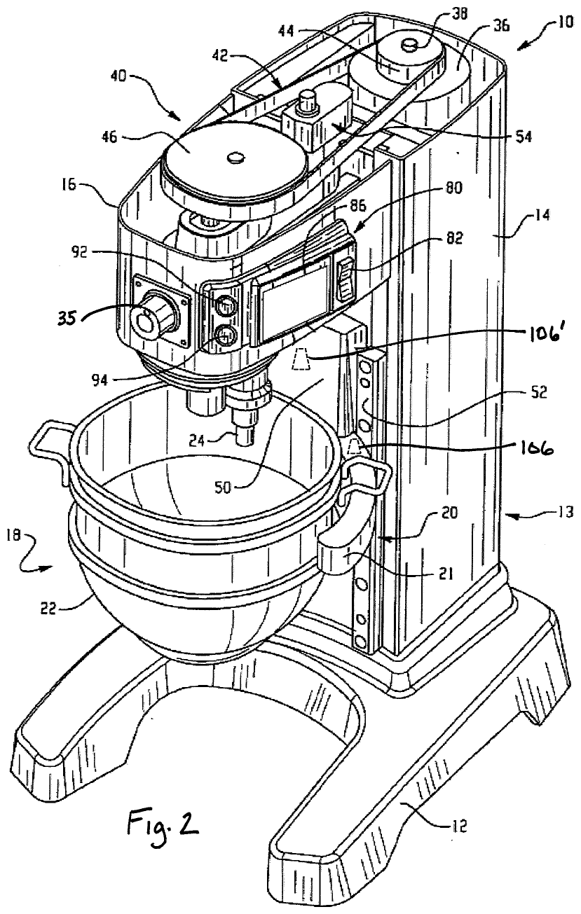

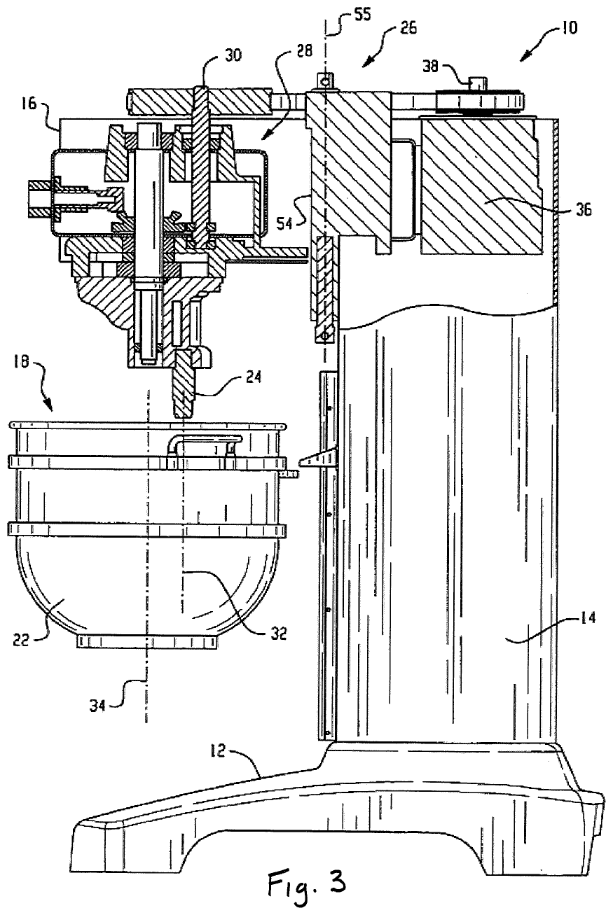

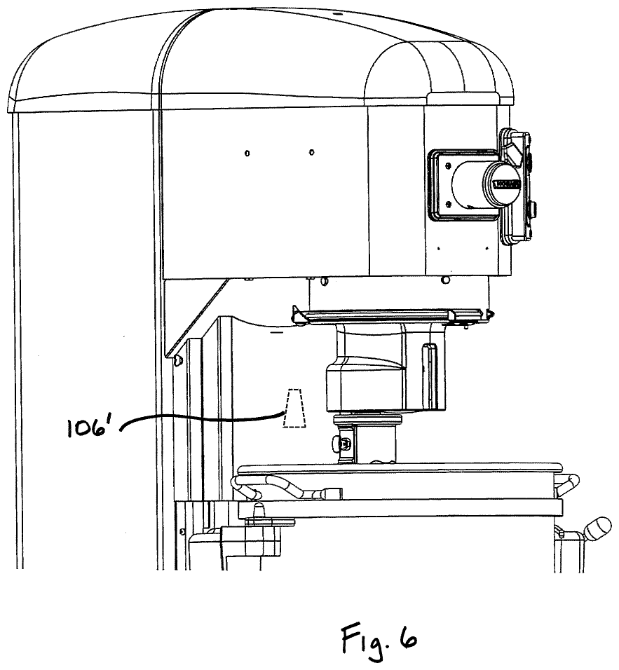

Referring to FIGS. 1-8, a mixing machine 10 includes a base 12, a mixer body 13 including a column 14 extending upward from the base 12, and a head 16 extending outward from the column 14 and over a bowl receiving location 18. The bowl receiving location 18 may be defined by a bowl receiving portion 20 of the mixer body 13, where the bowl receiving portion 20 has spaced apart curved arms 21 defining a curved shape to match the bowl 22 which is mountable thereto. The head includes a downwardly extending rotatable output member 24 (e.g., an output shaft) that can receive a mixing tool 25 such as dough hook, flat beater, whisk or other tool. The head 16 and upper portion of the column 14 typically include a detachable cover (not shown in FIG. 2) for enclosing the components.

The mixing machine includes a drive assembly 26 for effecting rotation of the rotatable output member 24. In the illustrated machine, the drive assembly is formed in part by a gear system 28 within the head 16 and having an upwardly extending input drive shaft 30. In the case of a planetary mixer, the gear system 28 may take the form of a planetary gear system, in which case the rotatable output member 24 rotates about its own axis 32, with the axis 32 orbiting around a central bowl axis 34. Also forming part of the drive assembly is a drive motor 36 that is mounted and located in line with the column 14 and includes an upwardly extending output shaft 38. A drive linkage 40 connects the motor output shaft 38 to the gear system input shaft 30 and may be formed by the illustrated belt 42 and pulleys 44 and 46. Alternative drive linkages could take the form of chain and sprocket combinations, additional gearing and/or or bar-type linkages.

The bowl receiving portion 20 may be mounted for vertical movement between a raised position toward the head 16 and a lowered position away from the head 16, the raised position being used during mixing operations and the lowered position being used for bowl installation and removal, as well as for installation and removal of mixing tools on the rotatable output member 24. In this regard, the curved arms 21 of the bowl receiving portion 20 connect with a central support 50 and the support 50 rides upward and downward on a pair of spaced apart guide rails 52 on the front side of the column 14. A power lift mechanism 54, such as a linear actuator with associated axis 55, may be provided for effecting upward and downward movement of the bowl receiving portion 20. This arrangement is further described in U.S. Pat. No. 6,883,959, but other systems for raising and lowering the bowl are also possible.

An exemplary user interface 80 is located on the head 16 and includes a plurality of input mechanisms including a bowl up/down switch 82 for activating the power bowl lift mechanism 54, a touch-screen (or other) display 86, a mix start button 92 and a mix stop button 94. Other user interface configurations are possible.

With respect to mixing tool and bowl identification, the mixing machine 10 includes a sensor system positioned for detecting each of (i) an identifier carried by a mixing tool attached to the output shaft and (ii) an identifier carried by a bowl mounted at the bowl receiving location. Here, the sensor system includes an RFID reader with an RFID antenna 102 positioned at the underside of the head near the planetary. In embodiments, the antenna 102 is capable of detecting an RFID component 120 of a tool 25 attached to the machine and an RFID component 122 or 122′ of the bowl 22 attached to the machine. The RFID component may for example, be any of an RFID chip, tag or label.

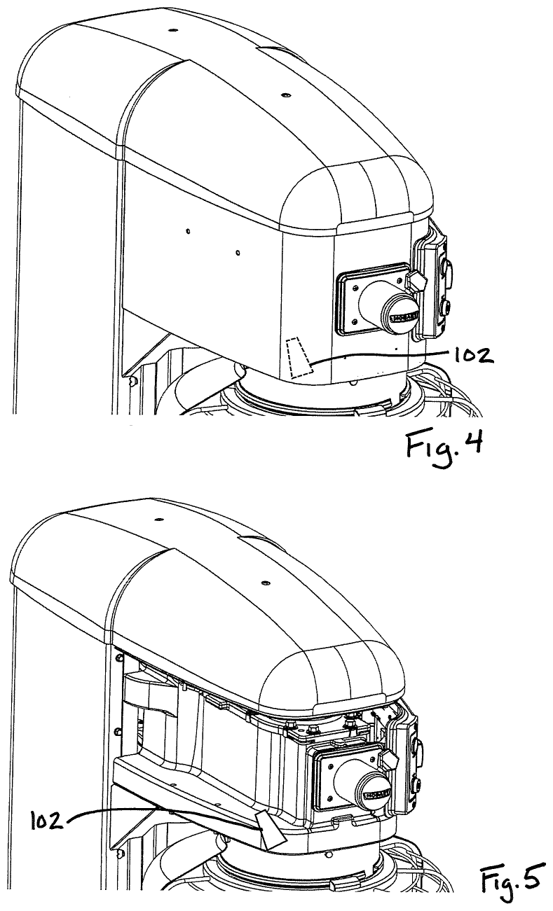

In embodiments, a single antenna 102 is used to detect both the tool and the bowl. However, in other embodiments, a distinct RFID antenna 106 could be provided on the bow receiving portion, or on or behind the central support 50 as at 106′, for detecting the identifier of the bowl, while antenna 102 detects the mixing tool identifier. FIGS. 4-6 show other views of exemplary positioning for antenna 102 and antenna 106′.

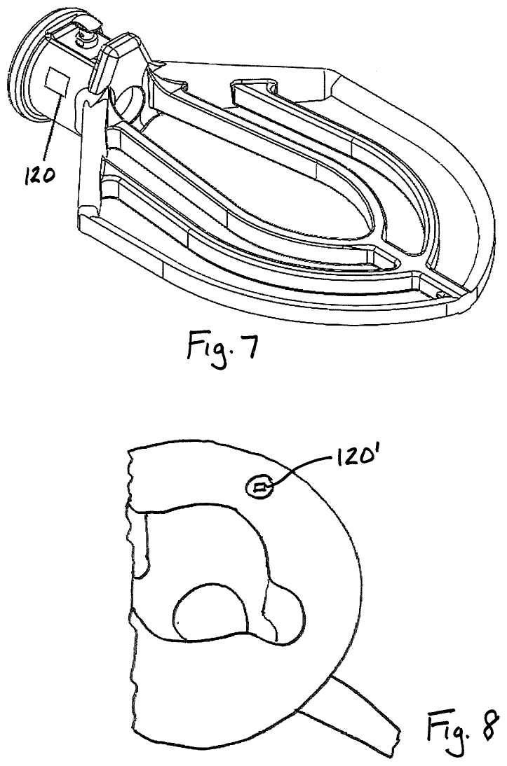

In embodiments, the mixing tool RFID component may be on a side region of a mount hub of the tool (e.g., per RFID component 120 in FIGS. 1 and 7). In other embodiments, the RFID component may be mounted in a channel or recess in an end face of the too mount hub (e.g., per RFID component 120′ in FIG. 8).

At the front of the head 16 a power take-off hub 35 is provided to which tools such as cutting and grinding tools, such as a vegetable slicer or meat chopper tool, can be attached. The machine could also include an antenna 105 positioned for detecting an RFID component of a tool attached to the power take off hub 35. As used herein, the term accessory encompasses both mixing tools that attach to the machine output shaft and processing tools that attach to the power take off hub.

The RFID antenna(s) connect (e.g., via suitable cabling/wiring) to an RFID reader circuit board (or boards) 104 that, here, is/are incorporated into/behind the user interface panel, which circuit board(s) in turn is associated with or part of the controller 110 of the mixing machine. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the device or the control functions of any component thereof.

In embodiments, each antenna could be associated with a distinct RFID reader. In other embodiments, multiple antennas could be associated with a single RFID reader.

In embodiments, the controller 110 is configured to utilize both the detected mixing tool identifier and the detected bowl identifier as a basis for implementing one or more control functions of the food mixing machine.

By way of example, the controller 110 may be configured to determine whether the detected mixing tool identifier and the detected bowl identifier indicated a specified mixing tool and bowl condition and, if so, to generate an operator alert of the condition. The specified condition could be an incompatibility between the detected mixing tool and the detected bowl (e.g., mixing tool too large for the bowl or mixing tool too small for the bowl). In such cases, the operator alert may be generated on the user interface directing the operator to select a compatible tool. The controller 110 may also prevent mixing operations of the machine and/or prevent raising of the bowl beyond a certain point in the case of such an incompatibility. The controller 100 may include memory with a stored record of compatible bowl sizes and mixing tool sizes and types. The RFID identifier for each mixing tool can be used to access a stored record that indicates tool type and size. Likewise, the RFID identifier for each bowl can be used to access a stored record of bowl size and/or shape.

The controller 110 may also configured to establish an operating bowl location based upon the detected mixing tool identifier and the detected bowl identifier so as to provide a suitable relative positioning of the mixing tool within the bowl for a mixing operation. In the case of mixing machines with a powered bowl lift mechanism, the controller 110 may automatically define the “bowl fully up” position to be used for mixing based upon the identified mixing tool and bowl combination on the machine, such that when the operator raises the bowl, the bowl stops at the appropriate location that is suited to the identified mixing tool and bowl. In addition, or alternatively, the controller 110 may automatically shift the bowl support to a suitable vertical location along the body of the mixing machine prior to initiating the mixing operation and/or may direct the operator (via the user interface) to adjust the vertical position of the bowl.

The controller 110 may also be configured such that, upon identification of a mixing accessory attached to the power take off hub 35, speed recommendations and/or instructions are displayed to the operator on the interface. The controller could also restrict the speeds available based upon a detected tool mounted to the hub 35.

In embodiments, each RFID component stores a readable identifier (e.g., serialized identification data) that is distinct and that identifies, in the case of a mixing tool, data identifying tool type and/or size, or, in the case of a bowl, bowl size and type (e.g., where type is specific to attachment features of the bowl). In more advanced implementations, each RFID component also stores additional readable data, such as revision data, manufacture data, part number data, order number data etc. for the tool or bowl. This additional data can be scanned by, for example, a service technician for the purpose of troubleshooting the machine.

In implementations, the data of each RFID component may be secured such that only approved bowls and tools can be utilized on the mixing machine. For example, mutual identification, lock password, basic access control or one-sided encryption techniques can be implemented by the reader(s) and RFID components. The controller of the machine is configured such that if a tool or bowl that does not comply with the applicable technique used, the machine will not run at all, will not run certain programs and/or will present an alert to the interface advising the operator to attach an acceptable tool.

In implementations, some or all of the stored data of the RFID components could be retrievable by a machine owner/user using a scanner provided with the machine or using a code or key that is provided with the machine and that can be implemented with certain third-party scanners available on the market or even a smart phone with appropriate RFID reading technology. Customers could use the data for desired inventory tracking and record keeping purposes.

In implementations, the controller is configured to store the RFID component data in memory for later retrieval, such as retrieval by a service or maintenance technician. This could provide the technician with useful information, such as what tools and bowls were attached at what times and what faults occurred when each was installed. Such data could also be uploaded to a cloud system, or other computer system, for retrieval, and could include data identifying the machine to which the tools and bowls were attached during certain conditions. Such data could also be uploaded to a cloud system, or other computer system, for retrieval, and could include data identifying the machine to which the tools and bowls were attached during certain conditions.

In implementations, the RFID reader(s) may be implemented as combination reader/writer devices that are capable of both reading data from, and writing data to, the RFID components. The data written to each RFID component could include usage data such as when the tool was attached to specific machines, which bowl was attached at the same time, and what faults or other specific conditions occurred and when. This would allow immediate access to troubleshooting data on site by the customer and/or service technician. For instance, if a certain location is breaking beaters regularly, the beater data could be scanned directly from the beater RFID component to provide the data on what agitator was installed on what mixer and what fault codes and conditions (overcurrent, overtemperature, mix time, mix speed, age of agitator etc.) occurred on the mixer while that agitator was installed. This enables consolidated tracking of usage conditions of multiple tools across multiple mixers.

In implementations, the mixing machine itself could include a readable/writable RFID component (e.g., per component 150 in FIG. 1) to which any or all of the foregoing data can be written, so to be easily retrievable by a customer or technician by simply scanning the RFID component 150. For example, the controller may be configured to cause an radio frequency identification reader/writer to write date to the component 150 in the case of fault conditions, in which case the data written may include each of the tool identifier, bowl identifier and mixing operation being implemented during the fault, as well as the exact point(s) in the mixing operation that the fault occurred. This would facilitate troubleshooting by a service technician on-site, who can easily read the data from the RFID component 150 using a hand-held reader/writer.

In implementations, the controller 100 may be configured to display specific information graphically show display of what mixing tool/bowl/processing tool is/are installed/not installed. Error codes can be displayed for impermissible combinations (attachment hub accessory+agitator accessory attached at the same time) and display helpful information about accessories (accessory name(s), size, use notes, hours on accessory, etc.). For example, if a customer attaches a dough hook and tries to run the machine in a speed that not recommended for this accessory, the machine displays an alert message and graphically displays the dough hook with an X through it for instance. In another example, installation of a 20 qt. stepdown bowl on a 40 quart machine with a 40 quart beater may be deemed an incorrect combination because the beater is too large for the bowl size. In such case, the controller may be configured to cause the display/screen 86 to display an alert message for the incompatible combination and show a graphical visualization of the bowl and beater with X's through them. In another example, if a specific accessory identifier has been logged with several instances of overcurrent or overtemperature condition occurring and is beyond a certain usage age, the controller may cause the display/screen 86 to display a visual indicating potential accessory wear and/or an alert to use the correct settings (operate in specific speeds, for a certain time, with specific accessories, etc.).

Generally, it is not desirable to operate the mixing machine with both a mixing tool operating on material in a bowl and a processing tool at the hub operating on material. To address this, in implementations, the controller 100 may be configured to prevent operation of the mixing machine if both a hub tool identifier and a mixing tool identifier are detected.

A variety of control features of the mixing machine could be limited, set or otherwise controlled based upon the specific identifier(s) of RFID components of tools and/or bowls that are detected on the machine, including speed, direction (clockwise or counterclockwise), frequency, bowl height, display screen information, mix time settings (e.g., maximum time and/or minimum time), motor acceleration and/or deceleration rate, allowable temperature limits (e.g., of the motor/motor controller) and/or allowable current limits (e.g., of the motor/motor controller).

It is to be clearly understood that the above description is intended by way of illustration and example only, is not intended to be taken by way of limitation, and that other changes and modifications are possible.

1. A food mixing machine, comprising:
a head extending over a bowl receiving location, the head including an output shaft driven in a planetary manner and configured to receive a mixing tool;
a sensor system configured for detecting a bowl identifier of a radio frequency identification component carried by a bowl mounted at the bowl receiving location.

2. The food mixing machine of claim 1, wherein the sensor system is configured for detecting a mixing tool identifier of a radio frequency identification component carried by a mixing tool connected to the output shaft.

3. The food mixing machine of the claim 2, wherein the sensor system includes at least one radio frequency identification reader connected with at least one radio frequency identification antenna.

4. The food mixing machine of claim 3, wherein the at least one radio frequency identification antenna comprises a single radio frequency identification antenna positioned for detecting both the radio frequency identification component carried by the mixing tool and the radio frequency identification component carried by the bowl.

5. The food mixing machine of claim 4, wherein the at least one radio frequency identification antenna comprises a first radio frequency identification antenna positioned for detecting the radio frequency identification component carried by the mixing tool, and a second radio frequency identification antenna positioned for detecting the radio frequency identification component carried by the bowl.

6. The food mixing machine of claim 2, further comprising:
a controller associated with the sensor system, the controller configured to utilize both the detected mixing tool identifier and the detected bowl identifier as a basis for implementing a control function of the food mixing machine.

7. The food mixing machine of claim 6, wherein the controller is configured to determine whether the detected mixing tool identifier and the detected bowl identifier indicate a specified condition and, if so, to generate, as the control function, an operator alert of the condition.

8. The food mixing machine of claim 6, wherein the controller is configured to establish, as the control function, an operating bowl location based upon the detected mixing tool identifier and the detected bowl identifier so as to provide a suitable relative positioning of the mixing tool within the bowl for a mixing operation.

9. The food mixing machine of claim 6, wherein the controller is configured to establish one or more of a mix speed, a mix direction, a mix time setting, a motor acceleration rate, a motor deceleration rate, an allowable temperature limit or an allowable current limit based upon at least one of a detected bowl identifier or a detected mixing tool identifier.

10. The food mixing machine of claim 2, wherein the mixing machine includes a power take off hub on the head, wherein the sensor system is further configured for detecting a hub tool identifier of a processing tool attached to the power take off hub.

11. The food mixing machine of claim 10, further comprising:
a controller associated with the sensor system, the controller configured to prevent operation of the mixing machine if both a hub tool identifier and a mixing tool identifier are detected.

12. The food mixing machine of claim 2, further comprising:
a controller associated with the sensor system, the controller configured to:
prevent operation of the mixing machine unless a bowl identifier is detected and verified as acceptable for the mixing machine; and/or
prevent operation of the mixing machine unless a mixing tool identifier is detected and verified as acceptable for the mixing machine

13. The food mixing machine of claim 1, further comprising:
a scannable RFID component on the mixing machine for identifying the mixing machine.

14. The food mixing machine of claim 13, wherein the sensor system includes at least one radio frequency identification reader/writer connected with at least one radio frequency identification antenna for writing operating data to the scannable RFID component of the mixing machine.

15. A food mixing machine, comprising:
a head extending over a bowl receiving location, the head including an output shaft driven in a planetary manner and configured to receive a mixing tool;
a sensor system configured for detecting (i) a bowl identifier of a radio frequency identification component carried by a bowl mounted at the bowl receiving location and (ii) a mixing tool identifier of a radio frequency identification component carried by a mixing tool connected to the output shaft;
a controller associated with the sensor system, the controller configured to implement a control function of the food mixing machine based upon at least both of the detected mixing tool identifier and the detected bowl identifier, wherein the control function is at least one of (i) display of an operator notification or (ii) establishment of an operating bowl location so as to provide a suitable relative positioning of the mixing tool within the bowl for a mixing operation.

16. A food mixing machine, comprising:
a head extending over a bowl receiving location, the head including an output shaft driven in a planetary manner and configured to receive a mixing tool;
a first readable/writable radio frequency identification component on the mixing machine that stores both (i) a readable identifier of the mixing machine and (ii) readable data regarding historical mixing machine operation.

17. The food mixing machine of claim 16, further comprising:
a radio frequency identification reader/writer on the mixing machine and configured for writing data to the first readable/writable radio frequency component; and
a controller operatively connected to the radio frequency identification reader/writer for implementing data write operations to the first readable/writable radio frequency identification component.
